(19) United States
(12) Patent Application Publication
(10) Pub. No.: US 2001/0019261 A1
(43) Pub. Date: Sep. 6, 2001

(54) Bandgap voltage reference source

(76) Inventor: Zhenhua Wang, Zurich (CH)

Correspondence Address: Corporate Patent Counsel, U.S. Philips Corporation, 580 White Plains Road, Tarrytown, NY, 10591, US

(21) Appl. No.: 09/761,255

(22) Filed: Jan. 16, 2001

(30) Foreign Application Priority Data
Jan. 19, 2000 (EP) 00200206.1

(51) Int. Cl. G05F 1/40

(52) U.S. Cl. 323/313

(57) ABSTRACT

A voltage reference source arrangement (10; 20) is described, comprising: first voltage reference means (2) for providing a first reference voltage (V_{B}) with a first temperature coefficient (α); a plurality (N) of second voltage reference means (3ᵢ) for providing compensation reference voltages (V_{C,i}) with second temperature coefficients (βᵢ), the sign of these second temperature coefficients (βᵢ) being opposite to the sign of the first temperature coefficient (α); and means (5ᵢ) for adding the first reference voltage (V_{B}) and the compensation reference voltages (V_{C,i}). Thus, the voltage reference source arrangement can be designed with high accuracy.

The present invention relates in general to a voltage reference source arrangement based on a bandgap voltage reference source.

Bandgap voltage reference sources are commonly known. Conventionally, a bandgap voltage reference source arrangement comprises a basic reference source having a negative temperature coefficient and a compensation reference source having a positive temperature coefficient. The voltage provided by the compensation reference source is amplified such that the positive temperature coefficient substantially compensates the negative temperature coefficient of the basic reference source, and a reference voltage is obtained with a zero temperature coefficient.

A problem with such conventional reference source arrangement is that the compensation reference source may suffer from an offset voltage due to mismatches. Any such offset voltage will be amplified in the conventional reference source arrangement, with the consequence that the accuracy is poor.

In the art, there is a need for precision voltage sources. For instance, in battery operated devices, it is important that a user is signalled when the battery voltage drops below a threshold value, indicating that the battery should be replaced or recharged. Further, almost all kinds of ADC and/or DAC require a precision voltage reference sources for operating correctly.

Therefore, it is a general objective of the present invention to provide a bandgap reference source arrangement with improved accuracy. Further, it is an objective of the present invention to provide a bandgap reference source arrangement where improved accuracy is an inherent property of the circuit design, without the need of complicated operations such as laser trimming, as is necessary in the current state of the art.

Further, in the art, there is a further need for a voltage reference source with very specific characteristics. Specifically, in a practical example, there is a need for a voltage reference source having an output voltage of exactly 1V at a temperature of 27° C. while delivering a current of 5 mA, whereas the temperature coefficient should be exactly −1 mV/°C. in a large temperature range. Therefore, a further objective of the present invention is to provide a bandgap reference source arrangement with a predetermined non-zero temperature coefficient.

The invention is based on the insight that the mismatch and consequent offset in a compensation reference source is substantially random, and that the offsets of different compensation reference sources are uncorrelated. Based on this insight, the present invention provides a voltage reference source arrangement having a plurality of compensation reference sources. The number of such plurality corresponds to the amplification factor applied to the conventional compensation reference source. However, instead of amplifying the output of one single compensation reference source, the outputs of said plurality of compensation reference sources are added together. Each of said compensation reference sources may suffer from an offset, but in view of the fact that those offsets are uncorrelated, they may statistically eliminate each other. Formulated more correctly, the offset in the sum is less than the sum of the same offsets.

These and other aspects, characteristics and advantages of the present invention will be firther clarified by the following description of a preferred embodiment of a voltage reference source arrangement in accordance with the invention, with reference to the drawings, in which same reference numerals indicate equal or similar parts, and in which:

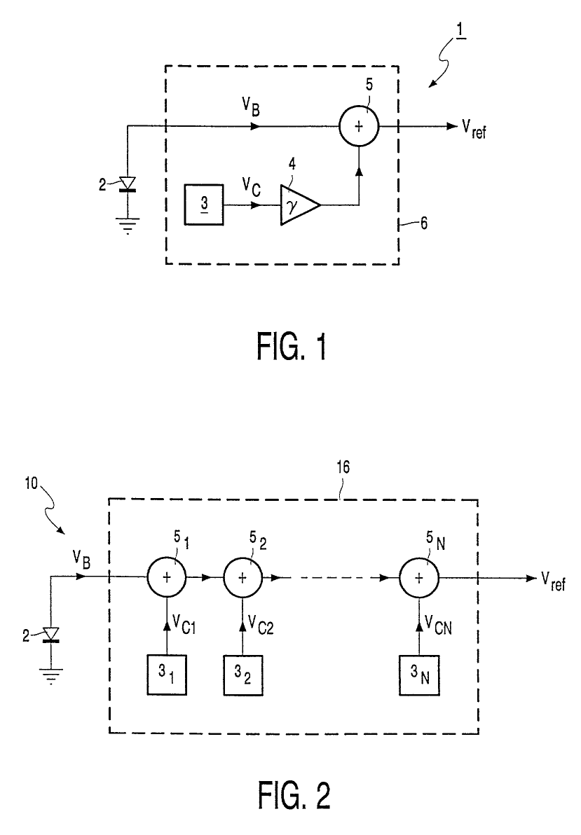

FIG. 1 is a circuit diagram illustrating the principles of a conventional voltage reference source arrangement;

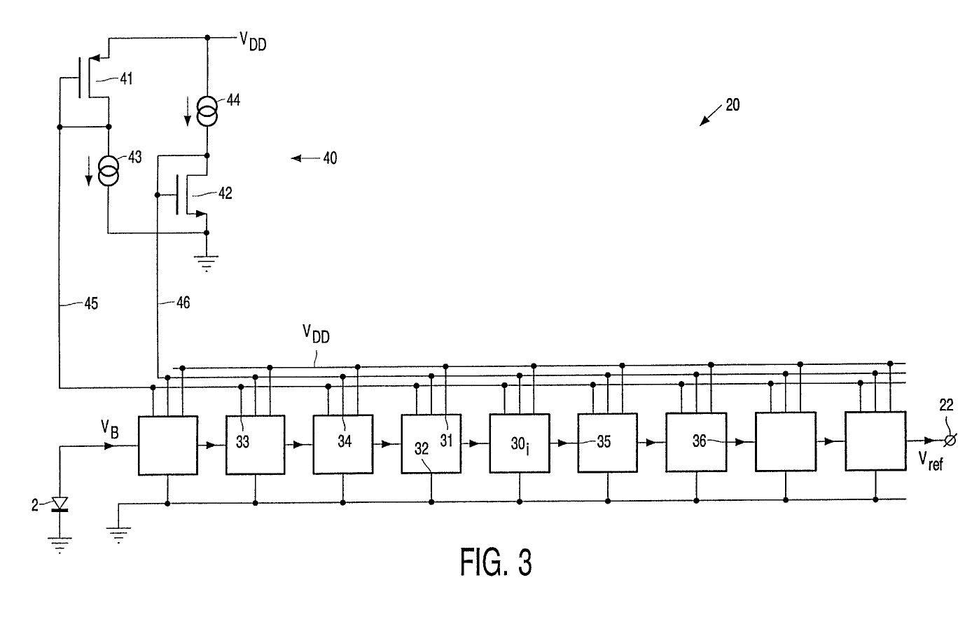

FIG. 2 is a circuit diagram illustrating the principles of a voltage reference source arrangement according to the present invention;

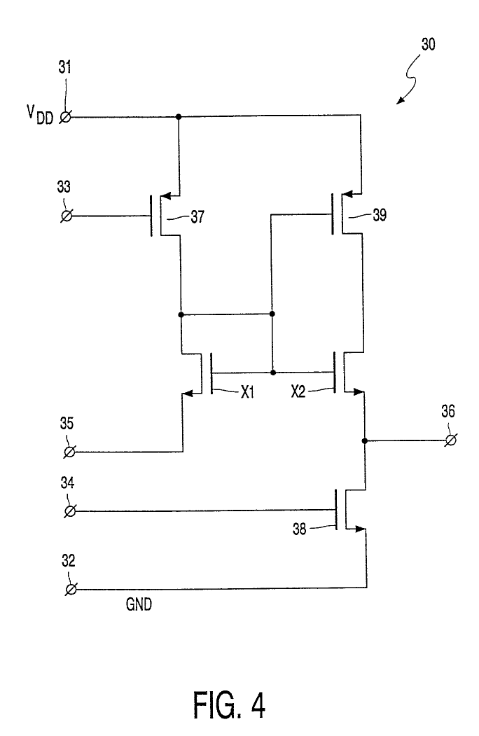

FIG. 3 is a circuit diagram illustrating a possible chip implementation of a voltage reference source arrangement according to the present invention;

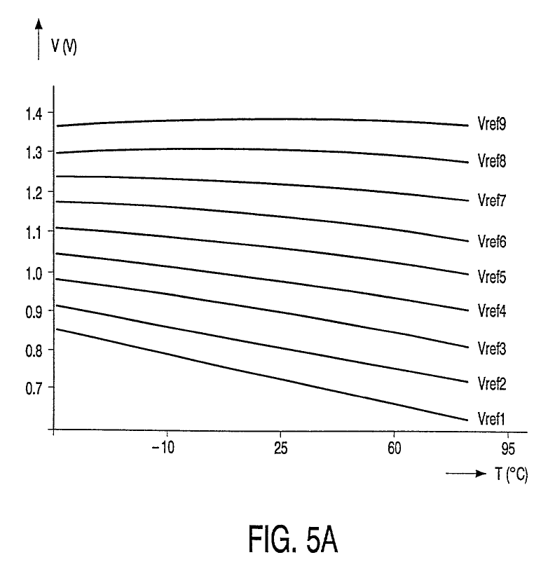

FIG. 4 is a circuit diagram illustrating a possible chip implementation of a compensation reference source for use in the voltage reference source arrangement of FIG. 3;

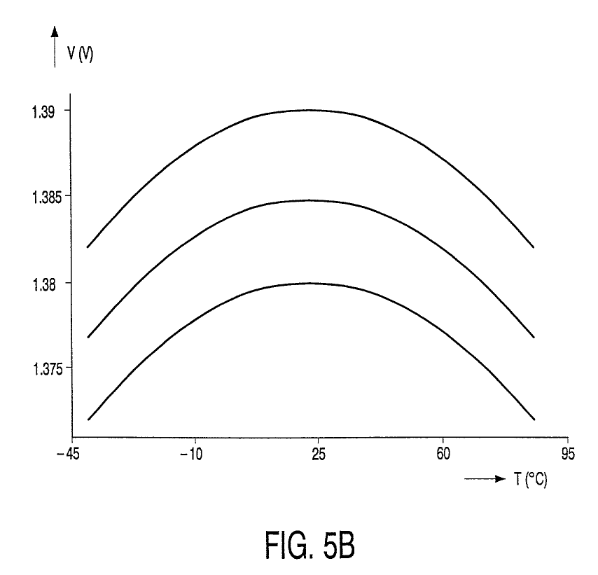

FIG. 5A is a graph showing the temperature characteristics of the voltage at subsequent stages in a simulated voltage reference source arrangement according to FIG. 3;

FIG. 5B is a graph showing the temperature characteristics of the output voltage of a simulated voltage reference source arrangement according to FIG. 3 for different values of the supply voltage.

FIG. 1 illustrates the principles of functioning of a conventional voltage reference source arrangement 1.

A PNjunction 2, for instance a diode, provides a basic reference voltage V_{B}. The PN-junction 2 has a temperature characteristic with an approximately constant, negative temperature coefficient α. This means that, in a first order approximation, the temperature dependent basic reference voltage V_{B} can be written as formula (1):

V_{B}(T)=V_{B}(T_{ref})+α·(T−T_{ref}) (1)

Herein,

V_{B}(T) is the value of the basic reference voltage V_{B} at a certain temperature T; and

V_{B}(T_{ref}) is the value of the basic reference voltage V_{B} at a reference temperature T_{ref}.

The negative temperature coefficient α is compensated in a compensation stage 6, which comprises a compensation reference source 3 based on the voltage difference between two PN-junctions (not shown) and providing a compensation reference voltage V_{C}. This compensation reference source 3 has a temperature characteristic with a positive temperature coefficient β. This means that, theoretically, the temperature dependent compensation reference voltage V_{C} can be ideally written as formula (2):

V_{C}(T)=V_{C}(T_{ref})+β·(T−T_{ref}) (2)

herein,

V_{C}(T) is the value of the compensation reference voltage V_{C} at a certain temperature T; and

V_{C}(T_{ref}) is the value of the compensation reference voltage V_{C} at a reference temperature T_{ref}.

The output voltage of compensation reference source 3 is amplified by an amplifier 4 with a voltage gain γ, which is chosen such that formula (3) is met:

δ=|α/β| (3)

From the above, it follows that, when designing the amplifier 4 of the circuit 1, the values of α and β must be known beforehand.

In an adder 5, the output voltage of the amplifier 4 is added to the basic reference voltage V_{B} of PN-junction 2 in order to provide the reference voltage V_{ref} according to formula (4):

$$\begin{matrix}{V}_{ref} ( T ) = γ \cdot {V}_{C} ( T ) + {V}_{B} ( T ) = \\ = γ \cdot [ {V}_{C} ( {T}_{ref} ) + β \cdot ( T - {T}_{ref} ) ] + \\ [ {V}_{B} ( {T}_{ref} ) + α \cdot ( T - {T}_{ref} ) ] \\ = γ \cdot {V}_{C} ( {T}_{ref} ) + {V}_{B} ( {T}_{ref} )\end{matrix} \qquad ( 4 )$$

Thus, the temperature coefficient of the reference voltage V_{ref} will be zero when equation (3) applies, and consequently V_{ref} will be equal to the bandgap voltage of the silicon.

The functioning of the compensation reference source 3 is based on the voltage difference between two PN-junctions, such as for instance two diodes, two bipolar transistors, or two MOS transistors operating in the weak inversion region with different area and/or with different current flowing into each. Due to mismatch in these two PN-junctions, and further due to imperfections in the amplifier 4, the compensation reference source 3 will, in practice, have an offset voltage V_{off} in addition to its designed compensation reference voltage V_{C}. Consequently, formula (2) changes into formula (2′):

V_{C}(T)=V_{C}(T_{ref})+β·(T−T_{ref})+V_{off} (2′)

and formula (4) changes into formula (4′):

V_{ref}(T)=γ·V_{C}(T_{ref})+V_{B}(T_{ref})+γ·V_{off} (4′)

Thus, the conventional design as illustrated in FIG. 1 has a drawback that any offset in compensation reference source 3, together with the input offset voltage of amplifier 4, is amplified by the gain γ of the amplifier 4. In practice, γ may be in the range of 8-14, and the reference voltage V_{ref} as produced by the voltage reference source arrangement 1 will have a relatively large offset voltage, which can be as high as 100 mV.

Further, when comparing a large number of identically designed voltage reference source arrangements 1, they will produce reference voltages which will not be identical to each other but which will spread around a mean value V₀ equal to γ·V_{C}(T_{ref})+ V_{B}(T_{ref}), due to the fact that the offset voltages V_{off} in the different compensation reference sources 3 will be random and uncorrelated.

FIG. 2 illustrates the principles of finctioning of a voltage reference source arrangement 10 according to the present invention. Similar to the conventional arrangement, a basic reference voltage V_{B} is provided by a PN-junction 2, for instance a diode, having a temperature characteristic with a negative temperature coefficient α such that the temperature dependent basic reference voltage V_{B} obeys formula (1):

V_{B}(T)=V_{B}(T_{ref})+α·(T−T_{ref}) (1)

Compensation for the negative temperature coefficient α is, again, provided by a compensation stage 16 on the basis of adding a voltage with a positive temperature coefficient. However, the compensation stage 16 according to the present invention comprises a plurality of N compensation reference sources 3₁, 3₂, . . . 3_{N}, each of which may be identical to the conventional compensation reference source 3 described above. Each individual compensation reference source 3ᵢ (i=1−N) provides a compensation reference voltage V_{C,i} which is added to the basic reference voltage V_{B}. In the example as illustrated, the compensation stage 16 according to the present invention comprises a plurality of N adders 5ᵢ, each having two inputs and an output, each having one input connected to a corresponding individual compensation reference source 3ᵢ to receive the corresponding compensation reference voltage V_{C,i}. As an alternative, the compensation stage 16 might have one adder with N+1 inputs and one output, as will be clear to a person skilled in the art.

The temperature dependent compensation reference voltage V_{C,i} of each individual compensation reference source 3ᵢ can be ideally written as formula (5):

V_{C,i}(T)=V_{C,i}(T_{ref})+βᵢ·(T−T_{ref}) (5)

herein,

V_{C,i}(T) is the value of the compensation reference voltage V_{C,i} at a certain temperature T;

V_{C,i}(T_{ref}) is the value of the compensation reference voltage V_{C,i} at a reference temperature T_{ref};

and βᵢ is the positive temperature coefficient of the compensation reference source 3ᵢ.

The output reference voltage V_{ref} of the voltage reference source arrangement 10 according to the present invention can be expressed as formula (6):

$$\begin{matrix}{V}_{ref} ( T ) = {V}_{B} ( T ) + \sum \{ {V}_{C , i} ( T ) \} = \\ = [ {V}_{B} ( {T}_{ref} ) + α \cdot ( T - {T}_{ref} ) ] + \\ \sum \{ {V}_{C , 1} ( {T}_{ref} ) + {β}_{i} \cdot ( T - {T}_{ref} ) \} \\ = {V}_{B} ( {T}_{ref} ) + \sum \{ {V}_{C , i} ( {T}_{ref} ) \} + \{ α + \sum {β}_{i} \} \cdot ( T - {T}_{ref} )\end{matrix} \qquad ( 6 )$$

wherein Σ denotes summation from i=1 to N.

Thus, the temperature coefficient of the reference voltage V_{ref} will be approximately zero when the absolute value of Σβᵢ is approximately equal to the absolute value of α.

If, for all compensation reference sources 3ᵢ, the temperature coefficients are equal to each other, then Σβᵢ can be written as Nβ, wherein N is the number of compensation reference sources.

As in the conventional design, the functioning of the compensation reference sources 3ᵢ is based on the voltage difference between two PN-junctions, and, due to mismatch in these two PN-junctions, the compensation reference sources 3ᵢ may, in practice, each have an offset voltage V_{off,i} in addition to their designed compensation reference voltage V_{C,i}. Consequently, formula (5) changes into formula (5′):

V_{C,i}(T)=V_{C,i}(T_{ref})+βᵢ·(T−T_{ref})+V_{off,I} (5′)

and formula (6) changes into formula (6′):

V_{ref}(T)=Vhd B(T_{ref})+Σ{V_{C,i}(T_{ref})}+{α+Σβᵢ}·(T−T_{ref})+ΣV_{off,I} (6′)

Now, as mentioned above, the offset voltages V_{off,i} of the compensation reference sources 3ᵢ are random and uncorrelated. Therefore, the sum ΣV_{off,i} of the offset voltages V_{off,i} will, in the mean, be less than N times the offset voltage V_{off} of one compensation reference source 3. In other words, the accuracy of the voltage reference source arrangement 10 is improved with respect to the accuracy of the conventional voltage reference source arrangement 1. Further, when comparing a large number of identically designed voltage reference source arrangements 10, they will show some spread around a mean value, but the spread will be reduced in comparison to the conventional spread. More particularly, when replacing a conventional arrangement in which a gain factor γ equal to N is employed by an inventive arrangement with N reference sources, the spread of the resulting reference voltages is reduced by \sqrt{N}. In practice, when N ranges from 8-14, the spread of the resulting reference voltages is reduced by 2.8-3.7.

If desired, a further improvement of the accuracy is possible by designing each compensation reference source 3ᵢ such that βᵢ is smaller, resulting in a larger value of N. However, since this would result in a more complex design, involving use of a larger silicon area and higher costs, a tradeoff has to be found between desired accuracy and acceptable costs when determining N.

Thus, in one aspect, an important advantage of the invention is to be recognised in the fact that random offsets are handled by averaging obtained by summation instead of multiplication obtained by amplification.

Further, the fact that an amplifier, including an op-amp and at least one resistor, is no longer needed constitutes an important advantage. The offset of the op-amp constitutes an important contribution to the total offset, and eliminating this op-amp also eliminates this offset contribution, resulting in an important decrease of the total offset.

FIG. 3 is a circuit diagram illustrating a possible chip implementation of a voltage reference source arrangement 20 according to the present invention. The circuit comprises a bias source 40, comprising a first P-transistor 41 and a second N-transistor 42. The first P-transistor 41 has its source coupled to a supply voltage V_{DD}, and has its drain coupled to ground GND through a first current source 43. The second N-transistor 42 has its source coupled to ground GND, and has its drain coupled to said supply voltage V_{DD} through a second current source 44. The gate of the first P-transistor 41 is connected to the drain of this first P-transistor 41, and constitutes a positive bias output 45 of the bias source 40. The gate of the second P-transistor 42 is connected to the drain of this second P-transistor 42, and constitutes a negative bias output 46 of the bias source 40.

The circuit 20 comprises further a plurality (in this case: nine) of compensation cells 30ᵢ, the implementation of which is illustrated more clearly in FIG. 4. Each compensation cell 30 has a supply voltage input 31, a second supply voltage input or ground input 32, a positive bias input 33, a negative bias input 34, a cell input 35 and a cell output 36. The supply voltage input 31 of each compensation cell 30 is connected to said supply voltage V_{DD}. The ground input 32 of each compensation cell 30 is connected to said ground GND. The positive bias input 33 of each compensation cell 30 is connected to said positive bias output 45 of the bias source 40. The negative bias input 34 of each compensation cell 30 is connected to said negative bias output 46 of the bias source 40. The cell input 35₁ of the first compensation cell 30₁ is connected to PN-junction 2 for receiving the basic reference voltage V_{B}. The cell input 35i of next compensation cells 30ᵢ is connected to the cell output 36ᵢ₋₁ of the corresponding previous compensation cell 30ᵢ₋₁. The cell output 36₉ of the last compensation cell 30₉ is connected to an output terminal 22 of the voltage reference source arrangement 20.

Each compensation cell 30ᵢ produces at its output 36ᵢ a cell output voltage V_{OUT,i} equal to the cell input voltage V_{IN,i} received at its input 35ᵢ plus a compensation voltage contribution V_{C,i}. Each compensation cell 30 comprises a first compensation N-transistor X1 and a second compensation N-transistor X2, having their gates connected together. Each compensation cell 30 comprises further a first bias P-transistor 37 and a second bias N-transistor 38, and a third bias P-transistor 39. The first bias P-transistor 37 has its source connected to the supply voltage input 31, has its gate connected to the positive bias input 33, and has its drain connected to the drain and the gate of the first compensation N-transistor X1. The second bias N-transistor 38 has its source connected to the ground input 32, has its gate connected to the negative bias input 34, and has its drain connected to the source of the second compensation N-transistor X2. The third bias P-transistor 39 has its source connected to the supply voltage input 31, has its gate connected to the gate node of the first and second compensation N-transistors X1 and X2, and has its drain connected to the drain of the second compensation N-transistor X2. The source of the first compensation N-transistor X1 is connected to the cell input 35; the source of the second compensation N-transistor X2 is connected to the cell output 36.

The two compensation transistors X1 and X2 are operating in the weak inversion. The first compensation N-transistor X1 receives a first bias current from the first bias P-transistor 37, and the second compensation N-transistor X2 receives a second bias current from the second bias N-transistor 38. In this design, the currents flowing through the two compensation transistors X1 and X2 are equal. However, the aspect ratio of the second compensation N-transistor X2 is Z times as large as the aspect ratio of the first compensation N-transistor X1. Therefore, a voltage difference ΔV is developed between the sources of the two compensation transistors X1 and X2, which implies that V_{OUT}=V_{IN}+ΔV.

Herein, ΔV=U_{T}·ln(Z), wherein U_{T}=25.9 mV at room temperature (300 K). It is noted that the DC-current flowing into the second P-transistor 42 is twice as large as the DC-current flowing into the first P-transistor 41.

Further, it is noted that the same current as flowing into the first bias P-transistor 37 is also applied to the output of the compensation cell 30. If the current flowing into the second bias N-transistor 38₉ of the last compensation cell 30₉ is reduced by 2 by halving its size, this additional current is no longer needed, leading to lower power dissipation.

The properties of the voltage reference source arrangement 20 shown in FIG. 3 have been examined in a simulation. The results are shown in FIG. 5A. The horizontal axis shows the device temperature in degrees Centigrade. The vertical axis shows voltage in Volt. The graph shows nine lines V_{ref,1}-V_{ref,9}, being the output voltages of the nine compensation cells 30ᵢ, respectively. The graph clearly shows that the output reference voltage V_{ref} of the voltage reference source arrangement 20, being equal to V_{ref,9} of FIG. 5A, is very stable with respect to temperature variations: over the range from −40° C. to +85° C., the temperature coefficient was as low as 46 ppm/°C. FIG. 5B, wherein the output reference voltage V_{ref,9} of FIG. 5A is shown for three different values of the supply voltage V_{DD} (3.5 V for the top curve, 3 V for the middle curve, and 2.5 V for the lower curve), the scale of the vertical axis being enlarged, shows this even more clearly. Further, the simulation of this design showed a supply voltage coefficient of 0.7% and a total current drain as low as 0.9 μA.

By comparing the output voltages of the nine compensation cells 30₁-30₉ as shown in FIG. 5A, it is clearly demonstrated that, when going from stage to stage, the output voltage increases due to addition of compensation voltage V_{C}, while further the temperature coefficient increases (from negative to approximately zero at room temperature) due to each compensation voltage V_{C} having a positive temperature coefficient.

In the above, the invention has been explained in respect of the objective of providing a reference voltage source of which the output voltage is accurate and stable, meaning that its temperature coefficient is as low as possible, preferably zero; graph V_{ref,9} of FIG. 5A, and also FIG. 5B, has demonstrated that this objective is attained, indeed. However, in some applications there is a need for a voltage reference source of which the output voltage has a temperature coefficient with a specified nonzero value. For instance, in a radio receiver there is a need for a reference voltage source having an output voltage of 1V at a temperature of 27° C. with a temperature coefficient of −1 mV/°C. in a large temperature range in order to compensate for the temperature coefficient of a lownoise amplifier. In accordance with the invention, such reference voltage source can easily be provided by choosing the number of compensation cells 30ᵢ in an appropriate way. For instance, with reference to FIG. 3 and FIG. 5A, more particularly graph V_{ref,4}, a voltage reference source arrangement 20 with four compensation cells would suffice to provide a temperature coefficient of approximately −1 mV/°C.

It should be clear to a person skilled in the art that the scope of the present invention is not limited to the examples discussed in the above, but that several amendments and modifications are possible without departing from the scope of the invention as defined in the appending claims.

In the above, it is explained that the temperature coefficient of the reference voltage V_{ref} will be zero when the absolute value of Σβi is equal to the absolute value of α. In other words, Σβi should ideally be equal to the absolute value of α; or, if all temperature coefficients are equal to each other, Nβ should ideally be equal to the absolute value of α, wherein N is the number of compensation reference sources. In practice, such will not always be possible. If the ratio |α/β is not an integer, another compensation reference source can be added, including an attenuator, i.e. an amplifier with a gain g smaller than 1, between the compensation reference source and its corresponding adder, as will be explained in the following.

Assume that |α/β| can be written as M+R, wherein M is an integer and R has a value between 0 and 1. Consider a compensation stage 16 as illustrated in FIG. 2, comprising N identical compensation reference sources 3ᵢ, in which N−1=M. Further, consider an amplifier connected between the output of the N-th compensation reference source 3_{N} and its corresponding adder 5_{N}, the amplifier having a gain g=R. From equation (6), it will be clear that the temperature coefficient of the reference voltage V_{ref} will be equal to zero:

{α+Σβᵢ}=α+(N−1)·β+g·β=α+(M+R)·β=0

Similar calculation applies if the compensation reference sources 3ᵢ have mutually different values for β. Also, the attenuator need not necessarily be associated with the last compensation reference source 3_{N} and its corresponding adder 5_{N}. Also, it is possible to have such attenuators associated with more than one compensation reference source.

1. Voltage reference source arrangement (10; 20), comprising:
first voltage reference means (2) for providing a first reference voltage (V_{B}) with a first temperature coefficient (α);
a plurality (N) of at least two second voltage reference means (3ᵢ; 39ᵢ) for providing compensation reference voltages (V_{C,i}) with second temperature coefficients (βᵢ), the sign of these second temperature coefficients (βᵢ) being opposite to the sign of the first temperature coefficient (α);
means (5ᵢ; 30ᵢ) for adding the first reference voltage (V_{B}) and the compensation reference voltages (V_{C,i}).

2. Voltage reference source arrangement according to claim 1, wherein the plurality (N) of second voltage reference means (3ᵢ; 30ᵢ) is in the range of 8-14.

3. Voltage reference source arrangement according to claim 1 or 2, comprising a plurality (N) of adders (5ᵢ), wherein each adder (5ᵢ) comprises two inputs and one output;
wherein the first adder (5₁) has its first input coupled to receive the first reference voltage (V_{B});
wherein for i>1, each adder (5ᵢ) has its first input connected to the output of a previous adder (5ᵢ₋₁);
and wherein each adder (5ᵢ) has its second input coupled to receive the compensation reference voltages (V_{C,i}) from an associated second voltage reference means (3ᵢ).

4. Voltage reference source arrangement according to claim 1, 2 or 3, comprising a plurality (N) of compensation cells (30ᵢ), wherein each compensation cell (30ᵢ) comprises a cell input (35ᵢ), a cell output (36ᵢ), and means (X1, X2) coupled between the cell input (35ᵢ) and the cell output (36₁), said means (X1, X2) being arranged for maintaining a voltage difference (V_{C,i}) between the cell output (36ᵢ) and the cell input (35ᵢ);
wherein the first compensation cell (30ᵢ) has its cell input (35ᵢ) coupled to receive the first reference voltage (V_{B});
and wherein for i>1, each compensation cell (30ᵢ) has its cell input (35ᵢ) connected to the cell output (36ᵢ) of a previous compensation cell (30ᵢ₋₁).

5. Voltage reference source arrangement according to claim 4, wherein said means (X1, X2) comprise a first compensation transistor (X1) of a first conductivity type and a second compensation transistor (X2) of the same conductivity type having their gates connected together, wherein the source of the first compensation transistor (X1) is connected to the cell input (35) and the source of the second compensation transistor (X2) is connected to the cell output (36).

6. Voltage reference source arrangement according to claim 5, wherein the first and second compensation transistors (X1, X2) are N-type;
wherein the drain of the first compensation transistor (X1) is coupled to a first supply voltage (V_{DD}) by a first bias P-transistor (37) having its gate connected to a positive bias input (33);
wherein the source of the second compensation transistor (X2) is coupled to a second supply voltage (GND) by a second bias N-transistor (38) having its gate connected to a negative bias input (34).

7. Voltage reference source arrangement according to claim 6, further comprising a third bias P-transistor (39) having its source connected to the first supply voltage (V_{DD}), having its drain connected to the drain of the second compensation N-transistor (X2), and having its gate connected to the gate node of the first and second compensation N-transistors.

8. Voltage reference source arrangement according to claim 5, 6, or 7, wherein the two compensation transistors (X1, X2) are operating in the weak inversion region.

9. Voltage reference source arrangement according claim 5, 6, 7, or 8, wherein the aspect ratio of the second compensation transistor (X2) is larger than the aspect ratio of the first compensation transistor (X1).

10. Voltage reference source arrangement according to any of the previous claims, wherein an attenuator is coupled between at least one of said second voltage reference means (3ᵢ; 30ᵢ) and the corresponding adding means (5ᵢ; 30ᵢ).
